(19) United States
(12) Patent Application Publication
(10) Pub. No.: US 2005/0187342 A1
(43) Pub. Date: Aug. 25, 2005

(54) Polyurethane-based thickeners

(76) Inventors: Ludwig Schieferstein, Ratingen (DE); Oliver Pietsch, Muelheim (DE)

Correspondence Address: COGNIS CORPORATION;PATENT DEPARTMENT, 300 BROOKSIDE AVENUE, AMBLER, PA, 19002, US

(21) Appl. No.: 11/059,747

(22) Filed: Feb. 17, 2005

(30) Foreign Application Priority Data
Feb. 19, 2004 (DE) 102004008015.1

(51) Int. Cl. C08K 3/20

(52) U.S. Cl. 524/591

(57) ABSTRACT

Thickeners based on an aqueous preparation of nonionic water-dispersible or water-soluble polyurethanes comprising constituent units provided by (a) at least one polyfunctional isocyanate; (b) at least one polyether polyol, (c) at least one monofunctional alcohol; and (d) optionally, at least one polyfunctional alcohol, wherein compound (d) contains no functional groups other than the OH groups, and component (c) comprises 2-(n-butyl)-1-octanol. The thickeners are distinguished by an excellent thickening effect, in aqueous dispersions.

### RELATED APPLICATIONS

This application claims priority from German application 102004008015.1 filed Feb. 19, 2004, the entire contents of which are incorporated by reference.

### FIELD OF THE INVENTION

This invention relates to thickeners based on an aqueous preparation of nonionic, water-dispersible or water-soluble polyurethanes of special structure.

### BACKGROUND OF THE INVENTION

Polyurethane-based associative thickeners are linear or branched nonionic polymers with hydrophilic and hydrophobic segments. They are increasingly replacing or augmenting the cellulose ethers traditionally used as thickeners in paints and lacquers and the alkali-soluble polyacrylates. Polyurethane thickeners offer the following advantages over these traditional thickeners:
lower viscosity during incorporation
lower tendency to splash during spreading
better color profile
higher gloss through minimal flocculation
lower sensitivity to water of the coatings
lower susceptibility to microbial infestation
low intrinsic viscosity in the final formulation and, hence, good dosing behavior
strong thickening effect in the dispersions to be thickened
minimal reduction in viscosity of the thickened dispersions on exposure to shearing, approximating Newtonian flow behavior.

Polyurethane thickeners of the type in question are known and are described, for example, in U.S. Pat. No. 4,079,028 and in U.S. Pat. No. 4,155,892. According to these patents, the polyurethanes are produced by reacting the following components (polymer units) with one another:
at least one water-soluble polyether polyol
at least one water-insoluble organic polyisocyanate
at least one monofunctional hydrophobic organic compound containing isocyanate-reactive hydrogen atoms and organic monoisocyanates and
at least one polyfunctional alcohol or polyfunctional ether alcohol.

The hydrophobic compounds structurally comprising an isocyanate-reactive hydrogen atom mentioned in U.S. Pat. No. 4,079,028 include inter alia fatty alcohols, such as methanol, ethanol, octanol, dodecanol, tetradecanol, hexadecanol and cyclohexanol (cf. column 9, lines 46-50).

EP-B-307,775 relates to water-dispersible modified polyurethanes in the form of reaction products of
a polyisocyanate,
a polyether polyol,
a modifying agent containing at least two active hydrogen units and at least one hydrophobic group, the modifying agent containing no groups capable of reacting with the polyisocyanate or the polyether polyol, and
a masking agent.

Suitable masking agents include inter alia primary alcohols, such as octanol, decanol, dodecanol, tetradecanol, hexadecanol, stearyl alcohol and 2-ethyl hexanol (cf. page 8, lines 51-52).

EP-B-612,329 relates to water-dispersible modified polyurethanes in the form of reaction products of
a polyisocyanate,
polyether polyols,
monofunctional alcohols and
if desired, polyfunctional alcohols,
   the monofunctional alcohols containing at least one other polar group non-reactive to isocyanates, namely an ester, amide and/or oxazoline group.

### BRIEF DESCRIPTION OF THE INVENTION

The problem addressed by the present invention was to provide polyurethane-based thickeners which would be distinguished from known polyurethane thickeners by a further distinct improvement in the above-mentioned advantages of polyurethane thickeners. In particular, the thickened product would show increased viscosity for the same quantity of thickener, despite the comparatively low intrinsic viscosity of the thickeners in the final formulation. In addition, a further approximation to Newtonian flow behavior would be achieved and, if desired, the thickeners could be produced without the use of volatile organic solvents.

According to the invention, the problem stated above has been solved by thickeners based on an aqueous preparation of nonionic water-dispersible or water-soluble polyurethanes obtainable by reaction of
(a) one or more polyfunctional isocyanates with
(b) one or more polyether polyols,
(c) one or more monofunctional alcohols and
(d) if desired, one or more polyfunctional alcohols, the compounds (d) containing no functional groups other than the OH groups,
   component (c) containing a branched primary alcohol of special structure, namely 2-(n-butyl)-1-octanol.

It has surprisingly been found that the polyurethanes according to the invention, which contain 2-(n-butyl)-1-octanol in copolymerized form as component (c), are distinguished from the polyurethanes according to U.S. Pat. No. 4,079,028 or U.S. Pat. No. 4,155,892 by a distinctly improved thickening effect in aqueous preparations (cf. also the Examples of the present application).

### DETAILED DESCRIPTION OF THE INVENTION

Component (a)

Suitable polyfunctional isocyanates (a) are any polyfunctional aromatic, alicyclic and aliphatic isocyanates. In a preferred embodiment, suitable polyfunctional isocyanates contain on average 2 to at most 4 NCO groups.

The following are mentioned as examples of suitable isocyanates: 1,5-naphthylene diisocyanate, 4,4′-diphenylmethane diisocyanate (MDI), hydrogenated MDI (H₁₂MDI), xylylene diisocyanate (XDI), tetramethyl xylylene diisocyanate (TMXDI), 4,4′-diphenyldimethylmethane diisocyanate, di- and tetraalkyl diphenylmethane diisocyanate, 4,4′-dibenzyl diisocyanate, 1,3-phenylene diisocyanate, 1,4-phenylene diisocyanate, the isomers of toluene diisocyanate (TDI), optionally in combination, 1-methyl-2,4-diisocyanatocyclohexane, 1,6-diisocyanato-2,2,4-trimethylhexane, 1,6-diisocyanato-2,4,4-trimethylhexane, 1-isocyanatomethyl-3-isocyanato-1,5,5-trimethyl cyclohexane, chlorinated and brominated diisocyanates, phosphorus-containing diisocyanates, 4,4′-diisocyanatophenyl perfluoroethane, tetramethoxybutane-1,4-diisocyanate, butane-1,4-diisocyanate, hexane-1,6-diisocyanate (HDI), dicyclohexylmethane diisocyanate, cyclohexane-1,4-diisocyanate, ethylene diisocyanate, phthalic acid-bis-isocyanatoethyl ester, polyisocyanates containing reactive halogen atoms, such as 1-chloromethylphenyl-2,4-diisocyanate, 1-bromomethylphenyl-2,6-diisocyanate, 3,3-bis-chloromethylether-4,4′-diphenyl diisocyanate. Sulfur-containing polyisocyanates are obtained, for example, by reaction of 2 mol hexamethylene diisocyanate with 1 mol thiodiglycol or dihydroxydihexyl sulfide. Other important diisocyanates are trimethyl hexamethylene diisocyanate, 1,4-diisocyanatobutane, 1,12-diisocyanatododecane and dimer fatty acid diisocyanate. Also of interest are partly masked polyisocyanates, which allow the formation of self-crosslinking polyurethanes, for example dimeric toluene diisocyanate, and polyisocyanates partly reacted with, for example, phenols, tert. butanol, phthalimide, caprolactam.

In a preferred embodiment of the invention, the polyfunctional isocyanates (a) used for the production of the polyurethanes at least predominantly contain isophorone diisocyanate (IPDI) and/or tetramethylxylene diisocyanate (TMXDI). Component (a) is preferably selected solely from the group consisting of isophorone diisocyanate (IPDI) and tetramethylxylene diisocyanate (TMXDI).

Particularly good results are obtained with TMXDI, especially since it is easier to handle during the reaction.

One embodiment is characterized by the use of isocyanates with a functionality of 2 (difunctional isocyanates).

In another embodiment, isocyanates with a functionality of more than 2 are partly or completely used where it is desired to produce branched polyurethanes.

Component (b)

Suitable polyether polyols (b) are, for example, the polymerization products of ethylene oxide, propylene oxide and/or butylene oxide, copolymerization or graft polymerization products thereof, the polyethers obtained by condensation of polyhydric alcohols or mixtures thereof and the polyethers obtained by alkoxylation of polyhydric alcohols, amides, polyamides and aminoalcohols. These polyether polyols are preferably so strongly hydrophilic that they are soluble in water.

Polyether polyols which at least predominantly contain polyalkylene glycols, more particularly polyethylene glycol and/or polypropylene glycol, are preferably used for the production of the polyurethanes according to the invention. Particularly good results are obtained where these polyalkylene glycols have an average content of alkoxy units of 20 to 500 and more particularly in the range from 100 to 250. Suitable diols preferably correspond to the following general formula:
HO—(CHR¹—CH₂O)ₙ—H
where n may assume a value of 20 to 500 and R¹ may be H or CH₃. Diols in which R¹=H and n=100 to 250, more particularly 120 to 180, are preferred. In a preferred embodiment, up to 90% by weight of the polyurethane molecule consists of the above-mentioned diol units.
Component (c)

Component (c) is selected from monofunctional alcohols. In the context of the present invention, monofunctional alcohols are understood to be alcohols which contain only one free OH group per molecule. This free OH group is preferably terminally positioned. It is expressly pointed out that the monofunctional alcohols may also contain additional ether groups (i.e. groups —O—). However, the monofunctional alcohols are preferably free from other functional groups.

As already mentioned, component (c) must contain a branched primary alcohol of special structure, namely 2-(n-butyl)-1-octanol. The choice of this special hydrophobic alcohol as a compulsory constituent of component (c) provides the polyurethanes according to the invention with excellent and unforeseeable properties in regard to the thickening effect of aqueous preparations.

It may be desirable for component (c) to contain one or more monofunctional alcohols in addition to 2-(n-butyl)-1-octanol. In that case, the percentage content of 2-(n-butyl)-1-octanol, based on all the monofunctional alcohols of component (c), is preferably more than 50% by weight.

In another embodiment, 2-(n-butyl)-1-octanol is the only monofunctional alcohol of component (c).

Component (d)

Polyfunctional alcohols (d) may be used as another component for the production of the polyurethanes. However, component (d) is optional. Alcohols with a functionality of 2 to 4 are particularly suitable. It is expressly pointed out that the components (d) are polyfunctional alcohols which contain no functional groups other than the OH groups. More particularly, it is pointed out that there is no overlap here with, for instance, the polyether polyols which, although containing several OH groups, must contain additional groups —O— (ether groups). One embodiment is characterized by the use of alcohols having a functionality of 2, i.e. diols, more particularly diols terminated by OH groups. If it is intended to produce branches in the synthesis of the polyurethane molecule, at least trifunctional starting materials need to be used. Branched polyurethanes as a basis for the thickeners according to the invention may be regarded as a particular embodiment of the invention. In this case, the polyfunctional alcohols (d) preferably at least predominantly contain trifunctional alcohols, such as glycerol for example. According to the invention, a preferred trifunctional alcohol is trimethylol propane (TMP). However, branches can also be produced in the synthesis of the polyurethane molecule by the use of isocyanates with a functionality of more than 2, preferably triisocyanates. To optimize the performance properties of the thickeners, it is advisable to confine such branches to a certain region within the polyurethane molecule.

Polyurethanes to be Used in Accordance with the Invention

In principle, the OH:NCO ratio of the polyurethanes to be used in accordance with the invention, which must contain components (a), (b) and (c), may be varied over a broad range, although a stoichiometric ratio or a ratio with a slight excess of OH groups of around 5 to 10% is preferred. In a preferred embodiment, the ratio is 1:1.

In addition, it is pointed out that the OH functional component (b) may even be at least partly replaced by analogous amine compounds.

In one embodiment of the invention, the polyurethane molecules are linear, i.e. do not have any branches. They correspond to the following general formula:
R²—O—[CO—NH—R³—NH—CO—O—(CHR¹—CH₂—O)ₙ]ₘ—CO—NH—R³—NH—CO—O—R²
wherein
R¹=H or CH₃, preferably H,
R²=residue of the monofunctional alcohol (c) reacted with isocyanate,
R³=residue of the diisocyanate (a) reacted with isocyanate-reactive OH groups,
n=20 to 500 and
m=1 to 60.
   Preferably, m=1 to 5. The best results are obtained where m=1 or 2.

In one embodiment, the polyurethanes to be used in accordance with the invention contain components (a), (b), (c) and (d).

In another embodiment, the polyurethanes to be used in accordance with the invention contain only components (a), (b) and (c).

In another embodiment, the polyurethanes to be used in accordance with the invention contain only components (a), (b) and (c), component (c) being exclusively 2-(n-butyl)-1-octanol.

The present invention also relates to thickener concentrates containing
(A) water,
(B) nonionic water-dispersible or water-soluble polyurethanes obtainable by reacting reaction of
   (a) one or more polyfunctional isocyanates with
   (b) one or more polyether polyols,
   (c) one or more monofunctional alcohols and
   (d) if desired, one or more polyfunctional alcohols, the compounds (d) containing no functional groups other than the OH groups,
   component (c) containing a branched primary alcohols of special structure, namely 2-(n-butyl)-1-octanol, and
(C) optionally one or more organic solvents and/or nonionic surfactants in the form of addition compounds of ethylene and/or propylene oxide onto C₈₋₁₈ fatty alcohols.

With regard to preferred embodiments in relation to the compounds (B), the foregoing observations apply.

The solvents (C) are volatile organic solvents. Examples of such solvents are low molecular weight alcohols, such as methanol, ethanol, n-propanol, i-propanol, n-butanol, i-butanol, sec. butanol, ethanediol, propanediol, butanediol, glycerol, trimethylol propane.

Preferred nonionic surfactants in the form of addition compounds of ethylene and/or propylene oxide with C₈₋₁₈ fatty alcohols (C) are those containing 2 to 4 mol ethylene oxide per mol fatty alcohol, for example Dehydol 04 (Cognis Deutschland GmbH & Co. KG).

The present invention also relates to the use of the thickeners or thickener concentrates according to the invention for thickening aqueous systems, preferably aqueous dispersions, selected from the group consisting of water-based automotive and industrial paints, printing and textile inks, pigmented printing pastes, water-based pharmaceutical or cosmetic formulations, plant protection formulations, filler and pigment dispersions, preparations of detergents, adhesives, waxes and polishes and for petroleum production, more particularly for thickening water-based plasters and paints in dispersion form.

### EXAMPLES

Polyurethane Production

### Example 1

207.1 g (24 mmol) Polyglycol E 8000 (polyethylene glycol of Dow Chemical; OH value 13) were introduced into a 1-liter four-necked flask which was then evacuated and purged with nitrogen twice. Vacuum was then applied and the contents of the flask were heated to 100° C. Water present was then removed over a period of two hours at that temperature under a vacuum of at least 10 mbar. The flask was then purged with nitrogen and the inert gas atmosphere was maintained by a gentle stream of nitrogen. The flask contents were stirred at 120 r.p.m. throughout the following reaction time. 8.9 g (48 mmol) 2-butyl-1-octanol, 11.7 g (48 mmol) m-tetramethyl xylylene diisocyanate (TMXDI, Cytec) and (as catalyst) 0.05 g 1,8-diazaabicyclo[5.4.0]undec-7-ene (Nitroil) were then successively added. During the addition and throughout the following reaction time, the temperature was kept at 110° C. When no more residual isocyanate could be detected (this was the case after ca. two hours), 139.1 g Dehydol 04 deo (addition product of 4 mol ethylene oxide onto 1 mol n-octanol; Cognis Deutschland GmbH & Co. KG) were added without further heating or cooling and the whole was stirred to homogeneity. The temperature fell to below 100° C. 347.8 g deionized water were then added and the whole was stirred to homogeneity. Ca. 700 g of a viscous, clear, pale yellowish polymer solution were isolated from the reaction vessel. The dry residue (determined by drying ca. 1-2 g of the polymer solution prepared as described above in a 10 cm aluminium dish for 1.5 h at 105° C. in a recirculating air drying cabinet) amounted to 48.0% by weight while the Brookfield viscosity measured 3.3 Pas (Brookfield RVT viscosimeter, spindle 6, 20 r.p.m., 22° C.).

### Comparison Example 1

The procedure was as described in Example 1 except that the 8.9 g (48 mmol) 2-butyl-1-octanol used in Example 1 was replaced by 6.2 g (48 mmol) n-octanol. The polymer solution obtained had a viscosity of 2.5 Pas.

### Comparison Example 2

The procedure was as described in Example 1 except that the 8.9 g (48 mmol) 2-butyl-1-octanol used in Example 1 was replaced by 7.6 g (48 mmol) n-decanol. The polymer solution obtained had a viscosity of 2.0 Pas.

### Comparison Example 3

The procedure was as described in Example 1 except that the 8.9 g (48 mmol) 2-butyl-1-octanol used in Example 1 was replaced by 8.9 g (48 mmol) n-dodecanol. The polymer solution obtained had a viscosity of 10 Pas.

### Comparison Example 4

The procedure was as described in Example 1 except that the 8.9 g (48 mmol) 2-butyl-1-octanol used in Example 1 was replaced by 9.6 g (48 mmol) i-tridecyl alcohol. The polymer solution obtained had a viscosity of 1.5 Pas.

Determination of Dispersion-Thickening Effect

### Example 1a

(Thickening Tests with the Polymer Solution of Example 1)

1.43 g of the polymer solution obtained as described in Example 1 (these 1.43 g of polymer solution contain ca. 0.40 g polyurethane, 0.29 g Dehydol O4 and 0.74 g water) were homogenized with a mixture of 31.4% by weight propanediol and 68.6% by weight water. 20 g of the aqueous polyacrylate dispersion Neocryl XK 90 (45% solids content; Neo Resins) were then added and the resulting mixture was stirred with a wooden spatula for ca. 2 minutes. After standing for at least 20 hours, the mixture was carefully restirred with a wooden spatula. Viscosity was then measured with a Haake RC 20-CPS-P Brookfield cone/plate viscosimeter (cone C50-1). It was found to be 680 mPas at a shear rate of 300 s⁻¹ and 145 mPas at a shear rate of 4,800 s⁻¹. Using an Epprecht cone/plate viscosimeter (measuring cone C), the ICI viscosity of the same sample was measured at 10,000 sec⁻¹. It was found to be 140 mPas.

The thickening effect of the polyurethane in the aqueous vinyl acetate/ethylene copolymer dispersion Mowilith LDM 1871 (53% solids content; Clariant) was measured in the same way with the Haake RC 20-CPS-P Brookfield cone/plate viscosimeter (cone C50-1). It was found to be 0.68 Pas at a shear rate of 300 s⁻¹ and 0.145 Pas at a shear rate of 4,800 s⁻¹.

### Comparison Examples 1a to 4a

(Thickening Tests with the Polymer Solutions of Comparison Examples 1 to 4)

The preparation of dispersions and the corresponding viscosity measurements were repeated as described in Example 1a except that the polymer solution obtained as described in Example 1 was replaced by the polymer solution obtained in accordance with Comparison Example 1 in the preparation of the dispersions.

The same procedure was adopted with the polymer solutions of Comparison Examples 2 to 4.

The results are set out in Table 1. In the interests of clarity, the viscosity data of Example 1a are also included in Table 1.

TABLE 1
Dispersion viscosities
(Example 1a and Comparison Examples 1a to 4a)

| | Dispersion viscosity [mPas] | | | | |
|---|---|---|---|---|---|
| | Dispersion | | | Dispersion | |
| | 1 (vi) | | | 2 (vii) | |
| | Brookfield | | Epprecht | Brookfield | |
| | RC20-CPS-P | | ICI visc. m. | RC20-CPS-P | |
| | 300 | 4800 | 10000 | 300 | 4800 |
| Polyurethane of | cm⁻¹ | cm⁻¹ | cm⁻¹ | cs⁻¹ | s⁻¹ |
| Example 1 (i) | 680 | 145 | 140 | 253 | 98 |
| Comp. Example 1 (ii) | 140 | 75 | 130 | 141 | 68 |
| Comp. Example 2 (iii) | 330 | 110 | 130 | 229 | 86 |
| Comp. Example 3 (iv) | 670 | 110 | 130 | 214 | 80 |
| Comp. Example 4 (v) | 260 | 95 | 130 | 167 | 75 |

(i) the polyurethane polymer of Example 1 contains 2-butyl-1-octanol as component (c)
(ii) the polyurethane polymer of Comparison Example 1 contains n-octanol as component (c)
(iii) the polyurethane polymer of Comparison Example 2 contains n-decanol as component (c)
(iv) the polyurethane polymer of Comparison Example 4 contains i-tridecyl alcohol as component (c)
(v) the polyurethane polymer of Comparison Example 4 contains i-tridecyl alcohol as component (c)
(vi) dispersion 1 is based on Neocryl XK 90 and is thus a polyacrylate dispersion
(vii) dispersion 2 is based on Mowilith LDM 1871 and is thus a vinyl acetate/ethylene copolymer dispersion

1: An aqueous thickener composition comprising a nonionic water-dispersible or water-soluble polyurethane containing constituent units derived from
(a) at least one polyfunctional isocyanate;
(b) at least one polyether polyol;
(c) at least one monofunctional alcohol; and
(d) optionally, at least one polyfunctional alcohol, wherein, the polyfunctional alcohol (d) contains no functional groups other than the OH groups, and component (c) comprises 2-(n-butyl)-1-octanol.

2: An aqueous thickener composition comprising a nonionic water-dispersible or water-soluble polyurethane containing constituent units derived from
(a) at least one polyfunctional isocyanate;
(b) at least one polyether polyol; and
(c) at least one monofunctional alcohol, wherein component (c) comprises 2-(n-butyl)-1-octanol.

3: The thickener as claimed in claim 1 wherein component (b) comprises at least one member selected from the group consisting of polyethylene glycols and polypropylene glycols.

4: The thickener as claimed in claim 2 wherein component (b) comprises at least one member selected from the group consisting of polyethylene glycols and polypropylene glycols.

5: A thickener composition comprising a nonionic water-dispersible or water-soluble polyurethane comprising constituent units derived from
(a) at least one polyfunctional isocyanate;
(b) at least one polyether polyol; and
(c) 2-(n-butyl)-1-octanol.

6: A thickener as claimed in claim 5, wherein, component (b) comprises at least one member selected from the group consisting of polyethylene glycols and polypropylene glycols.

7: A thickener as claimed in claim 1, wherein, component (a) comprises at least one member selected from the group consisting of isophorone diisocyanate (IPDI) and tetramethyl xylene diisocyanate (TMXDI).

8: A thickener as claimed in claim 2, wherein, component (a) comprises at least one member selected from the group consisting of isophorone diisocyanate (IPDI) and tetramethyl xylene diisocyanate (TMXDI).

9: A thickener as claimed in claim 3, wherein, component (a) comprises at least one member selected from the group consisting of isophorone diisocyanate (IPDI) and tetramethyl xylene diisocyanate (TMXDI).

10: A thickener as claimed in claim 4, wherein, component (a) comprises at least one member selected from the group consisting of isophorone diisocyanate (IPDI) and tetramethyl xylene diisocyanate (TMXDI).

11: A thickener as claimed in claim 5, wherein, component (a) comprises at least one member selected from the group consisting of isophorone diisocyanate (IPDI) and tetramethyl xylene diisocyanate (TMXDI).

12: A thickener concentrate comprising:
(A) water,
(B) a nonionic water-dispersible or water-soluble polyurethane comprising constituent units derived from
(a) at least one polyfunctional isocyanate;
(b) at least one polyether polyol;
(c) at least one monofunctional alcohol;
(d) optionally, at least one polyfunctional alcohol, wherein, the polyfunctional alcohol (d) contains no functional groups other than the OH groups; and component (c) comprises 2-(n-butyl)-1-octanol; and
(C) optionally, at least one member selected from the group consisting of organic solvents and nonionic surfactants, which surfactants comprise addition products of at least one of ethylene oxide and propylene oxide onto C₈₋₁₈ fatty alcohols.

13: A water-containing dispersion paint containing a thickening effective amount of the thickener of claim 1.

14: An aqueous dispersion containing a thickener concentrate of claim 12.

15: The aqueous dispersion of claim 14, wherein, the aqueous dispersion comprises a cosmetic preparation.
